(19) United States
(12) Patent Application Publication
(10) Pub. No.: US 2004/0197123 A1
(43) Pub. Date: Oct. 7, 2004

(54) HOLDER FOR VARIABLE-SIZED IMAGE RECORDING MEDIUMS

(75) Inventor: Wen-Chao Tseng, Taichung (TW)

Correspondence Address: LOWE HAUPTMAN GILMAN & BERNER, LLP, Suite 310, 1700 Diagonal Road, Alexandria, VA, 22314, US

(73) Assignee: VEUTRON CORPORATION

(21) Appl. No.: 10/407,211

(22) Filed: Apr. 7, 2003

(51) Int. Cl. G03G 15/00

(52) U.S. Cl. 399/377

(57) ABSTRACT

A holder for variable-sized image recording mediums is provided. The holder includes a first outer frame member, a second outer frame member, a third outer frame member, a fourth outer frame member, at least one first rail and at least one second rail. The first outer frame member is symmetrical to the second outer frame member, and each of which has a groove formed in one side thereof along a longitudinal dimension and opposite to each other. The third outer frame member is symmetrical to the fourth outer frame member, and each of which has a groove formed in one side thereof along a longitudinal dimension and opposite to each other. The horizontal level of the groove of the first outer frame member is different from that of the groove of the third outer frame member. The first rail and second rail are positioned in the area enclosed by the outer frame members. The first rail is movably inserted in the grooves of the third and fourth outer frame members. The second rail is movably inserted in the grooves of the first and second outer frame members. A holder with variable-sized enclosures is thus obtained.

### BACKGROUND OF THE INVENTION

1. Field of the Invention

The present invention relates to a holder for image recording mediums, and more particularly to a holder for variable-sized image recording mediums.

2. Description of the Prior Art

The original to be scanned with a scanner can be divided into two different categories, reflective and transparent. In order to effectively scan the image from the original, the scanners are configured to reflective type for scanning the reflective original, and transparent type for scanning the transparent original.

Referring to FIG. 1, a typical reflective type scanner is shown. The reflective type scanner 1 generally includes a scanning window 11, which is a plane surface made of for example glass or other light transmittable, substantially rigid material, for supporting a reflective original 12 to be scanned. The reflective type scanner 1 generally includes an optical scanning module 13 provided with a light source 14, a plurality of light reflection mirrors 151, 152, 153 and 154, a focusing lens 16, and an image sensing module 17, such as a charge-coupled device (CCD) or a contact image sensor (CIS). The optical scanning module 13 may be moved by a driving device (not shown) along the double-arrow direction. When the optical scanning module 13 completes a scanning process, the image of the reflective original 12 is scanned.

As shown in FIG. 2, a typical transparent type scanner 2 is shown. The transparent type scanner 2 also includes a scanning window 21. A back light module provided with a back light source 22 is positioned above the scanning window 21. The transparent type scanner 2 includes an optical scanning module 23 provided with a plurality of light reflection mirrors 241, 242 and 243, a focusing lens 25, and an image sensing module 26. The optical scanning module 23 may be moved by a driving device (not shown) along the double-arrow direction. When the optical scanning module 23 completes a scanning process and with the light provided by the back light source 22, the image of the transparent original 27 supported on the scanning window 21 is scanned.

Transparent type and reflective type scanners are different in structure and are used with image recording media of different natures. Reflective type scanners are typically suited to media with relatively high reflectivity, such as paper, film, etc. Transparent type scanners, on other hand, are suited for use with media made from materials with relatively high transparence, such as negatives and slides, or projection film. The scanners of both types also can be used to scan various-sized image recording mediums. However, a user desires to scan small-sized image recording mediums, such as negatives, positives, slides, or some other small-sized articles having patterns formed thereon, a media fixing apparatus 3, as shown in FIG. 3, is appended above the scanning window to keep the image recording mediums unmoved during the scanning process. The media fixing apparatus 3 includes a plurality of compartments 31, each of which has a constant enclosure. Thus, only the image recording mediums with the same size can share the media fixing apparatus 3. It is necessary to use different media fixing apparatuses to hold the image recording mediums with different sizes, and thus those image recording mediums can not be scanned during one scanning cycle. It is uneconomic, inconvenient and time-wasted for the user desires to scan various-sized image recording mediums.

Accordingly, it is an intention to provide a holder suitable for various-sized image recording mediums, which can overcome the above drawback.

### SUMMARY OF THE INVENTION

It is one objective of the present invention to provide a holder for variable-sized image recording mediums, which can flexibly adjust a holding enclosure depending on the size of an image recording medium to be held.

It is another objective of the present invention to provide a holder for variable-sized image recording mediums, in which image recording mediums with various sizes can share this holder.

In order to achieve the above objectives of this invention, the present invention provides a holder for various-sized image recording mediums. The present holder includes a first outer frame member, a second outer frame member, a third outer frame member, a fourth outer frame member, at least one first rail and at least one second rail. The first outer frame member has a groove formed in one side thereof along a longitudinal dimension, and the second outer frame member has a groove formed in one side thereof along a longitudinal dimension. The grooves of the first outer frame member and the second outer frame member are opposite to each other and at the same horizontal level. The third outer frame member is connected to one end of the first outer frame member and the second outer frame member, and has a groove formed in one side thereof along a longitudinal dimension. The groove of the third outer frame member is at a horizontal level different from that of the groove of the first outer frame member. The fourth outer frame member is connected to the other end of the first outer frame member and the second outer frame member, and has a groove formed in one side thereof along a longitudinal dimension. The grooves of the third outer frame member and the fourth outer frame member are opposite to each other and at the same horizontal level. The first rail is positioned between the first outer frame member and the second outer frame member, two ends of the first rail are movably inserted in the grooves of the third outer frame member and the fourth outer frame member, respectively. The second rail is positioned between the third outer frame member and the fourth outer frame member, and two ends of the second rail are movably inserted in the grooves of the first outer frame member and the second outer frame member, respectively. As a consequence, several variable-sized enclosures are formed in the holder.

### BRIEF DESCRIPTION OF THE DRAWINGS

The objectives and features of the present invention as well as advantages thereof will become apparent from the following detailed description, considered in conjunction with the accompanying drawings.

FIG. 1 is a schematic cross-sectional view of a typical reflective type scanner;

FIG. 2 is a schematic cross-sectional view of a typical transparent type scanner;

FIG. 3 is a schematic top view of a well-known media fixing apparatus;

FIG. 4A is a schematic perspective view of a holder for various-sized image recording mediums in accordance with a first embodiment of the present invention;

FIG. 4B is a schematic perspective view of a holder for various-sized image recording mediums in accordance with a second embodiment of the present invention;

FIG. 5A is a schematic perspective view of a holder for various-sized image recording mediums in accordance with a third embodiment of the present invention;

FIG. 5B is a schematic perspective view of a holder for various-sized image recording mediums in accordance with a fourth embodiment of the present invention;

FIG. 6A is a schematic perspective view of a holder for various-sized image recording mediums in accordance with a fifth embodiment of the present invention;

FIG. 6B is a schematic perspective view of a holder for various-sized image recording mediums in accordance with a sixth embodiment of the present invention;

FIG. 7A to 7D is schematic perspective views of variances of a first outer frame member of the holder of the present invention;

FIG. 8 is a schematic perspective view of a third outer frame member of the holder of the present invention;

FIG. 9A to 9C is schematic perspective views of variances of a first rail of the holder of the present invention; and

FIG. 10A to 10B is schematic perspective views of variances of a second rail of the holder of the present invention.

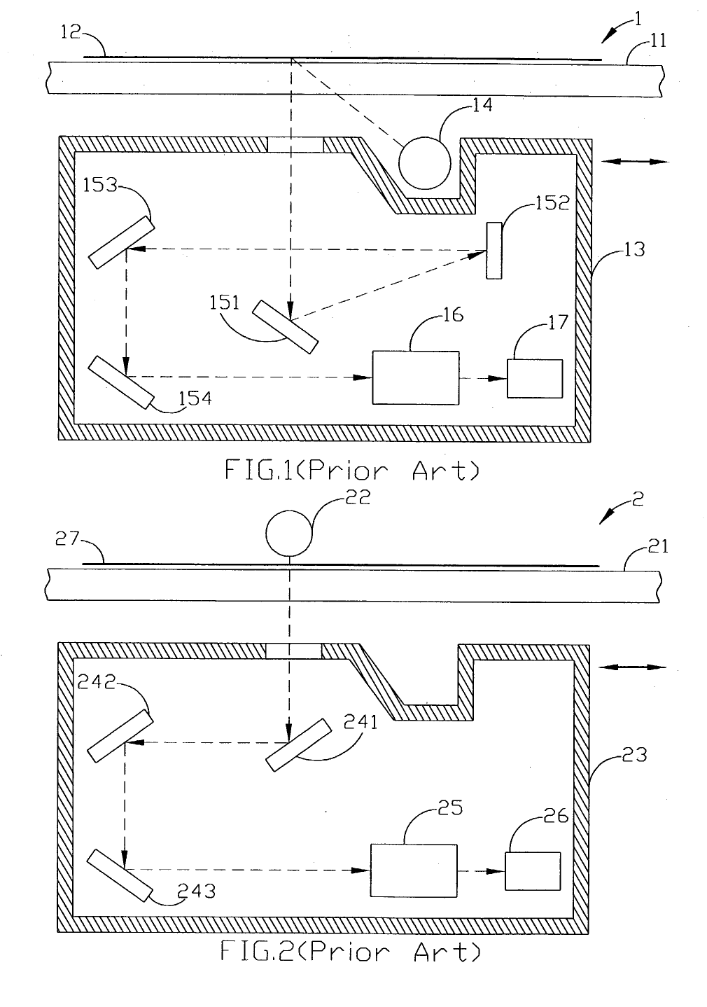

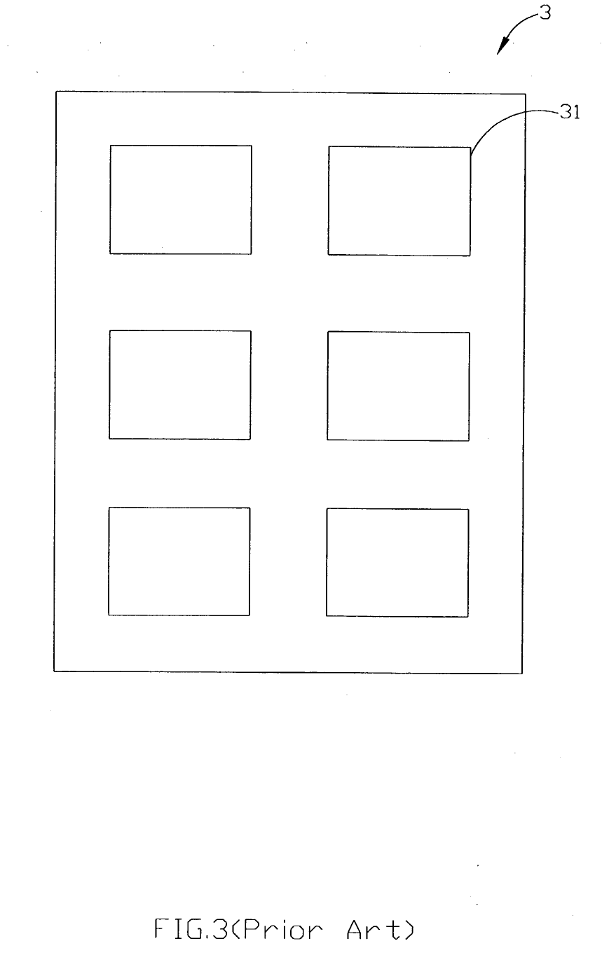

### DESCRIPTION OF THE PREFERRED EMBODIMENT

The present invention provides a holder with a plurality of adjustable enclosures for holding various-sized image recording mediums in place during a scanning process. The enclosures of the present holder are flexibly adjusted depending on the sizes of the image recording mediums to be held. The user can use the present holder to keep the image recording mediums with various sizes unmoved during one scanning cycle. It is convenient and time-saved for image scanning.

The present holder will be described in detail in accordance with embodiments of the present invention, as follows.

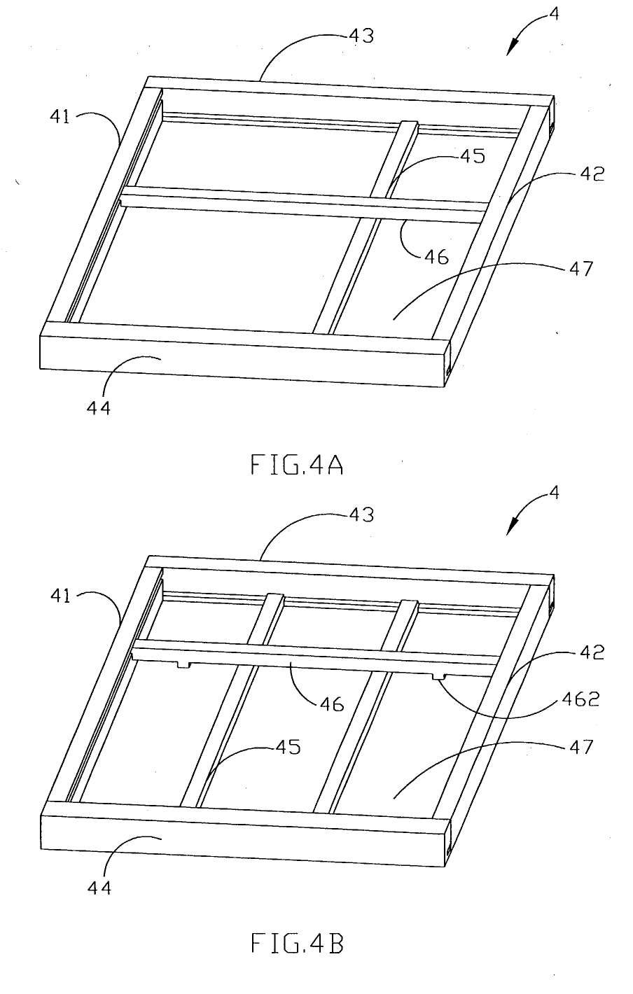

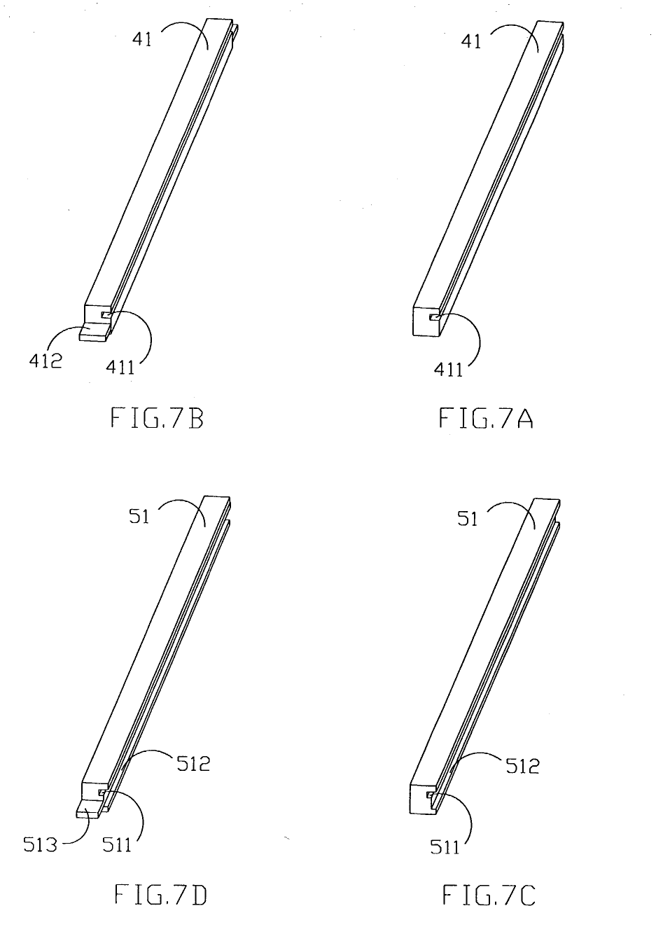

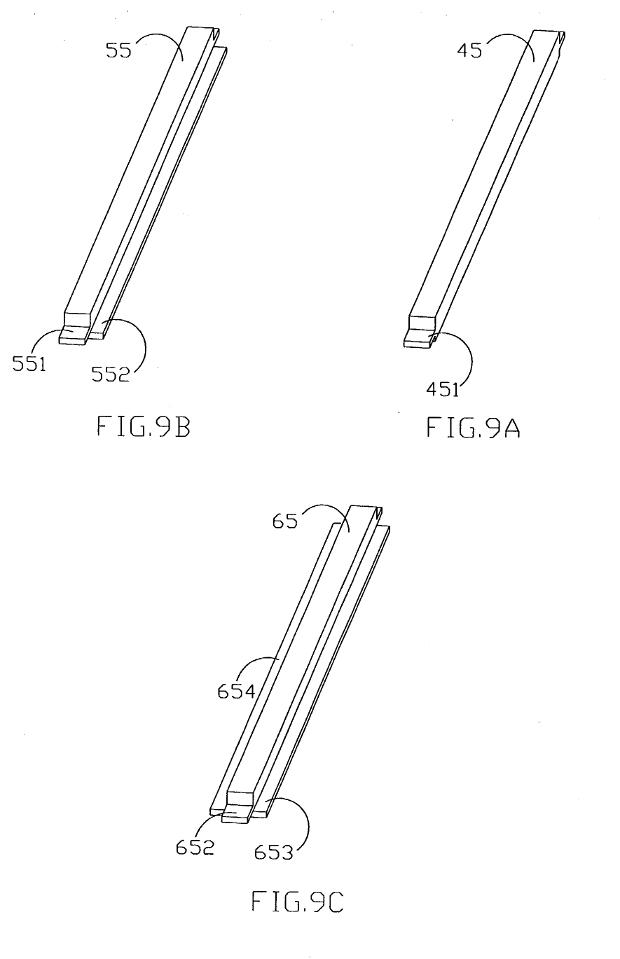

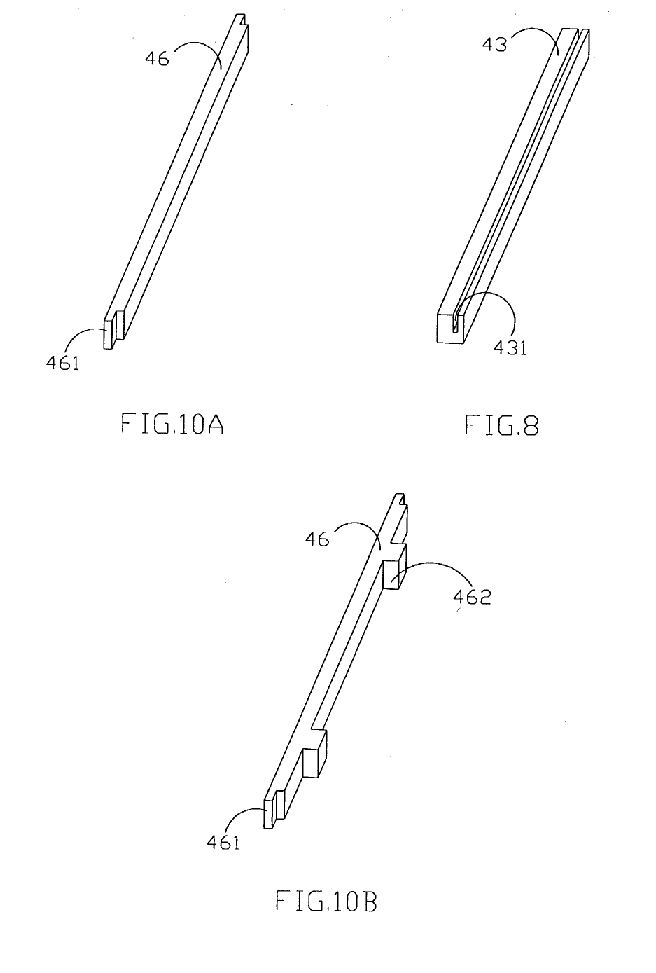

FIG. 4A is a schematic perspective view of the present holder in accordance with a first embodiment of the present invention. The holder 4 of the first embodiment includes a first outer frame member 41, a second outer frame member 42, a third outer frame member 43, a fourth outer frame member 44, at least a first rail 45 and at least one second rail 46. Referring to FIG. 7A, the first outer frame member 41 has a groove 411 formed in one side thereof along a longitudinal dimension. The second outer frame member 42 is symmetrical to the first outer frame member 41, having a groove formed in one side thereof along a longitudinal dimension opposite to the groove 411 of the first outer frame member, and both grooves are at the same horizontal level. Referring to FIG. 8, the third outer frame member 43 has a groove 431 formed in one side thereof along a longitudinal dimension. The third outer frame member 43 is connected to one end of the first outer frame member 41 and the second outer frame member 42. The groove 431 of the third outer frame member 43 is at a horizontal level different from that of the groove 411 of the first outer frame member 41. The fourth outer frame member 44 is symmetrical to the third outer frame member 43, having a groove formed in one side thereof along a longitudinal dimension opposite to the groove 431 of the third outer frame member 43, and both grooves are at the same horizontal level. The fourth outer frame member 44 is connected to the other end of the first outer frame member 41 and the second outer frame member 42. Both of the first outer frame member 41 and the second outer frame member 42 can be connected to the third outer frame member 43 and the fourth outer frame member 44 by adhesive, such as glue. Alternately, see FIG. 7B, it is preferable that a protrusion 412 is extended from each end of the first outer frame member 41 and the second outer frame member 42 for being inserting the grooves 431 of the third outer frame member 43 and the fourth outer frame member 44. The first rails 45 are positioned between the first outer frame member 41 and the second outer frame member 42. Two ends of each first rail 45 is movably inserted in the grooves 431 of the third outer frame member 43 and the fourth outer frame member 44, respectively. See FIG. 9A, it is preferable that a protrusion 451 is extended from each end of the first rail 45 for being movably inserted in the grooves 431 of the third outer frame member 43 and the fourth outer frame member 44. The second rail 46 is positioned between the third outer frame member 43 and the fourth outer frame member 44. Two ends of the second rail 46 are movably inserted in the grooves 411 of the first outer frame member 41 and the second outer frame member 42, respectively. Referring to FIG. 10A, it is preferable that a protrusion 461 is extended from each end of the second rail 46 for being movably inserted in the grooves 411 of the first outer frame member 41 and the second outer frame member 42. The first rails 45 can be slid in the grooves 431 of the third outer frame member 43 and the fourth outer frame member 44. The second rail 46 can be slid in the grooves 411 of the first outer frame member 41 and the second outer frame member 42. As a consequence, the holder 4 can provide several enclosures 47 with different sizes. That is, the enclosures 47 can be flexibly adjusted to comply with the sizes of the image recording mediums to be held therein. Therefore, several image recording mediums with different sizes can share the holder 4, and can be scanned during one scanning cycle.

FIG. 4B is a schematic perspective view of the present holder in accordance with a second embodiment of the present invention. The holder 4 of the second embodiment is the same with the holder 4 of the first embodiment except that a plurality of protruded block 462 is extended downward from one side of the second rail 46 for resisting against the first rails 45, see FIG. 10B.

FIG. 5A is a schematic perspective view of the present holder in accordance with a third embodiment of the present invention. The holder 5 includes a first outer frame member 51, a second outer frame member 52, a third outer frame member 53, a fourth outer frame member 54, a plurality of first rails 55 and at least a second rail 56. Referring to FIG. 7C, the first outer frame member 51 has a groove 511 formed in one side thereof along a longitudinal dimension and an extended plate 512 from the side having the groove 511 formed therein and opposite to the groove 511. The second outer frame member 52 is symmetrical to the first outer frame member 51. The second outer frame member 52 has a groove formed in one side thereof along a longitudinal dimension opposite to the groove 511 of the first outer frame member 51 and an extended plate from the side thereof having the groove formed therein and opposite to the groove. Referring to FIG. 8 again, the third outer frame member 53 has the same structure with the third outer frame member 43 of the holder 4 of the first embodiment, having a groove 531 formed in one side thereof along a longitudinal dimension. The third outer frame member 53 is connected to one end of the first outer frame member 51 and the second outer frame member 52. The groove 531 of the third outer frame member 53 is at a horizontal level different from that of the groove 511 of the first outer frame member 51. The fourth outer frame member 54 is symmetrical to the third outer frame member 53, having a groove formed in one side thereof along a longitudinal dimension opposite to the groove 531 of the third outer frame member 53, and both grooves are at the same horizontal level. The fourth outer frame member 54 is connected to the other end of the first outer frame member 51 and the second outer frame member 52. Both of the first outer frame member 51 and the second outer frame member 52 can be connected to the third outer frame member 53 and the fourth outer frame member 54 by adhesive, such as glue. Alternately, see FIG. 7D, it is preferable that a protrusion 513 is extended from each end of the first outer frame member 51 and the second outer frame member 52 for being inserting the grooves of the third outer frame member 53 and the fourth outer frame member 54. The first rails 55 are positioned between the first outer frame member 51 and the second outer frame member 52. Two ends of each first rail 55 is movably inserted in the grooves of the third outer frame member 53 and the fourth outer frame member 54, respectively. See FIG. 9B, it is preferable that a protrusion 551 is extended from each end of the first rail 55 for being movably inserted in the grooves 531 of the third outer frame member 53 and the fourth outer frame member 54. The first rail 55 neighboring with the first outer frame member 51 has an extended plate 552 from the side opposite to the extended plate 512 of the first outer frame member 51. The first rail 55 neighboring with the second outer frame member 52 also has an extended plate 552 from the side opposite to the extended plate of the second outer frame member 52. The second rail 56 is positioned between the third outer frame member 53 and the fourth outer frame member 54. Two ends of the second rail 56 are movably inserted in the grooves 511 of the first outer frame member 51 and the second outer frame member 52, respectively. Referring to FIG. 10A again, it is preferable that a protrusion is extended from each end of the second rail 56 for being movably inserted in the grooves 511 of the first outer frame member 51 and the second outer frame member 52. The first rails 55 can be slid in the grooves 531 of the third outer frame member 53 and the fourth outer frame member 54. The second rail 56 can be slid in the grooves 511 of the first outer frame member 51 and the second outer frame member 52. As a consequence, the holder 5 can provide several enclosures 57 with different sizes for holding various-sized image recording mediums. The extended plates 512 and 552 of the first outer frame member 51, the second outer frame member 52 and the first rail 55 can be used to support the image recording mediums held therein.

FIG. 5B is a schematic perspective view of the present holder in accordance with a fourth embodiment of the present invention. The holder 5 of the fourth embodiment is the same with the holder 5 of the third embodiment except that a plurality of protruded blocks 562 is extended downward from one side of the second rail 56 for resisting against the first rails 55, like the second rail 46 of FIG. 10B.

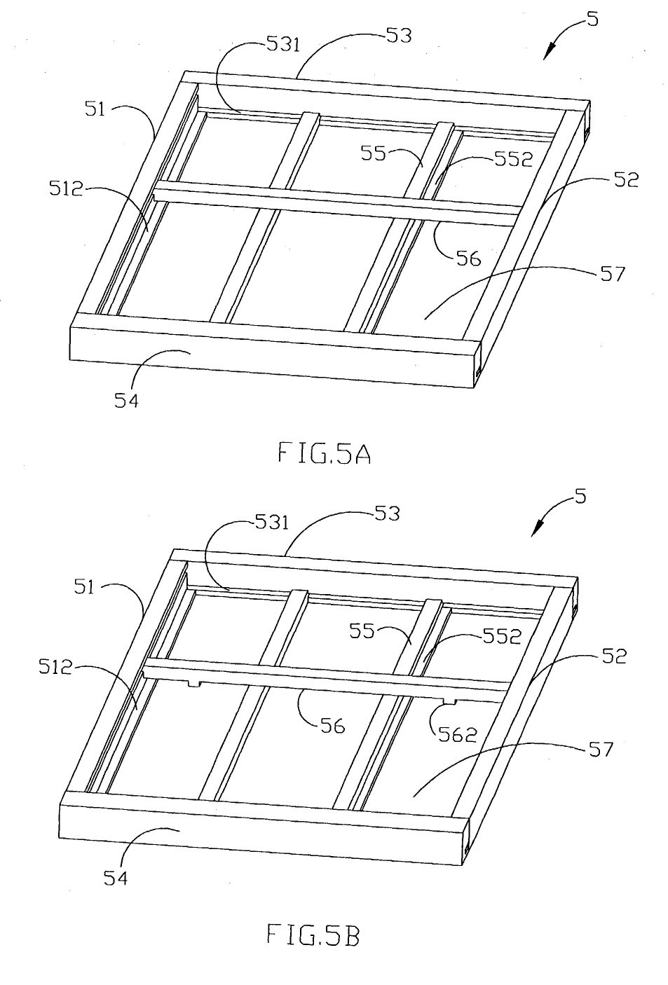

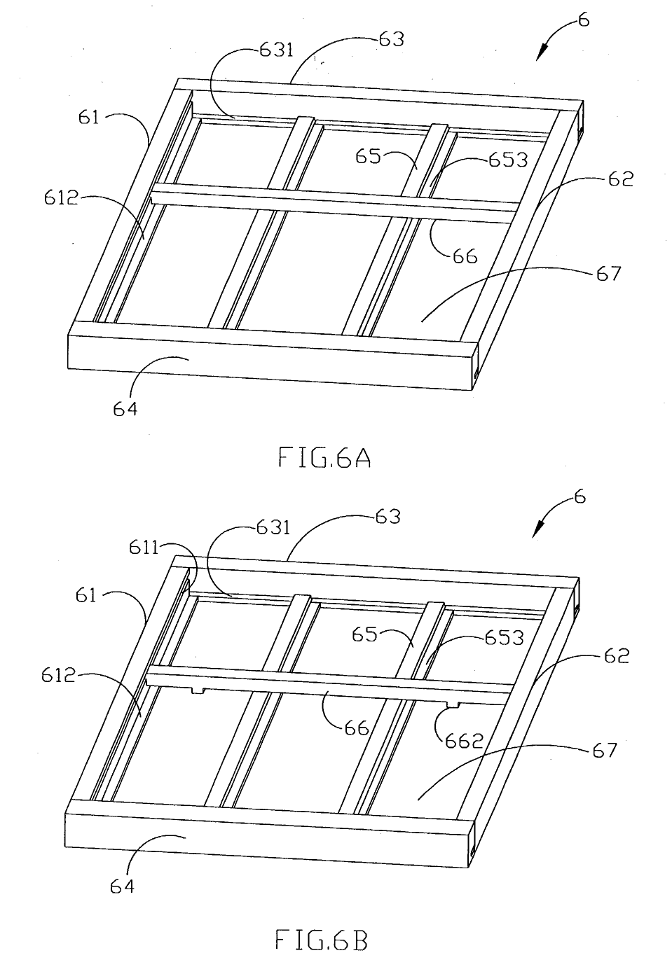

FIG. 6A is a schematic perspective view of the present holder in accordance with a fifth embodiment of the present invention. The holder 6 includes a first outer frame member 61, a second outer frame member 62, a third outer frame member 63, a fourth outer frame member 64, a plurality of first rails 65 and at least a second rail 66. Referring to FIG. 7C again, the first outer frame member 61 has a groove 611 formed in one side thereof along a longitudinal dimension and an extended plate 612 from the side having the groove 611 formed therein and opposite to the groove 611. The second outer frame member 62 is symmetrical to the first outer frame member 61. The second outer frame member 62 has a groove formed in one side thereof along a longitudinal dimension opposite to the groove 611 of the first outer frame member 61 and an extended plate from the side thereof having the groove formed therein and opposite to the groove. Referring to FIG. 8 again, the third outer frame member 63 has the same structure with the third outer frame member 43 of the holder 4 of the first embodiment, having a groove 631 formed in one side thereof along a longitudinal dimension. The third outer frame member 63 is connected to one end of the first outer frame member 61 and the second outer frame member 62. The groove 631 of the third outer frame member 63 is at a horizontal level different from that of the groove 611 of the first outer frame member 61. The fourth outer frame member 64 is symmetrical to the third outer frame member 63, having a groove formed in one side thereof along a longitudinal dimension opposite to the groove 631 of the third outer frame member 63, and both grooves are at the same horizontal level. The fourth outer frame member 64 is connected to the other end of the first outer frame member 61 and the second outer frame member 62. Both of the first outer frame member 61 and the second outer frame member 62 can be connected to the third outer frame member 63 and the fourth outer frame member 64 by adhesive, such as glue. Alternately, see FIG. 7D, it is preferable that a protrusion is extended from each end of the first outer frame member 61 and the second outer frame member 62 for being inserted in the grooves 631 of the third outer frame member 63 and the fourth outer frame member 64. The first rails 65 are positioned between the first outer frame member 61 and the second outer frame member 62. Referring to FIG. 9C, each of the first rails 65 has two extended plates 653 and 654 respectively from the two sides thereof and at the same horizontal level with the extended plates 612 of the first outer frame member 61 and the second outer frame member 62. Two ends of each first rail 65 is movably inserted in the grooves 631 of the third outer frame member 63 and the fourth outer frame member 64, respectively. See FIG. 9C again, it is preferable that a protrusion 652 is extended from each end of the first rail 65 for being movably inserted in the grooves 631 of the third outer frame member 63 and the fourth outer frame member 64. The second rail 66 is positioned between the third outer frame member 63 and the fourth outer frame member 64. Two ends of the second rail 66 are movably inserted in the grooves 611 of the first outer frame member 61 and the second outer frame member 62, respectively. Referring to FIG. 10A again, it is preferable that a protrusion is extended from each end of the second rail 66 for being movably inserted in the grooves 611 of the first outer frame member 61 and the second outer frame member 62. The first rails 65 can be slid in the grooves 631 of the third outer frame member 63 and the fourth outer frame member 64. The second rail 66 can be slid in the grooves 611 of the first outer frame member 61 and the second outer frame member 62. As a consequence, the holder 6 can provide several enclosures 67 with different sizes for holding various-sized image recording mediums. The extended plates 612, 653 and 654 of the first outer frame member 61, the second outer frame member 62 and the first rail 65 can be used to support the image recording mediums held therein.

FIG. 6B is a schematic perspective view of the present holder in accordance with a sixth embodiment of the present invention. The holder 6 of the sixth embodiment is the same with the holder 6 of the fifth embodiment except that a plurality of protruded blocks 662 is extended downward from one side of the second rail 66 for resisting against the first rails 65, like the second rail 46 of FIG. 10B.

The embodiments are only used to illustrate the present invention, not intended to limit the scope thereof. Many modifications of the embodiments can be made without departing from the spirit of the present invention.

What is claimed is:

1. A holder for variable-sized image recording mediums, comprising:
a first outer frame member having a groove formed in one side thereof along a longitudinal dimension;
a second outer frame member having a groove formed in one side thereof along a longitudinal dimension, said grooves of said first outer frame member and said second outer frame member opposite to each other and at the same horizontal level;
a third outer frame member having a groove formed in one side thereof along a longitudinal dimension, said third outer frame member connected to one end of said first outer frame member and said second outer frame member, and said groove of said third outer frame member at a horizontal level different from that of said groove of said first outer frame member;
a fourth outer frame member having a groove formed in one side thereof along a longitudinal dimension, said fourth outer frame member connected to the other end of said first outer frame member and said second outer frame member, and said grooves of said third outer frame member and said fourth outer frame member opposite to each other and at the same horizontal level;
at least one first rail positioned between said first outer frame member and said second outer frame member, two ends of said first rail movably inserted in said grooves of said third outer frame member and said fourth outer frame member, respectively; and
at least one second rail positioned between said third outer frame member and said fourth outer frame member, two ends of said second rail movably inserted in said grooves of said first outer frame member and said second outer frame member, respectively, so that a plurality of variable-sized enclosures are formed in said holder.

2. The holder of claim 1, wherein said first rails has a protrusion extended from each end thereof for being movably inserted in said grooves of said third outer frame member and said fourth outer frame member, respectively.

3. The holder of claim 1, wherein said second rail has a protrusion extended from each end thereof for being movably inserted in said grooves of said first outer frame member and said second outer frame member, respectively.

4. The holder of claim 1, wherein each of said first outer frame member and said second outer frame member has a protrusion extended from each of the ends thereof connected to said third outer frame member and said fourth outer frame member for being inserted in said grooves of said third outer frame member and said fourth outer frame member.

5. The holder of claim 1, wherein said second rail has a plurality of protruded blocks extended downward from one side thereof for resisting against said first rails.

6. The holder of claim 1, wherein each of said first outer frame member and said second outer frame member has an extended plate from the side having said groove formed therein and opposite to said groove, and each of said first rails has an extended plate from each of the sides thereof opposite to each other and at the same horizontal level of said extended plates of said first outer frame member and said second outer frame member.

7. The holder of claim 2, wherein said second rail has a plurality of protruded blocks extended downward from one side thereof for resisting against said first rails.

8. The holder of claim 3, wherein said second rail has a plurality of protruded blocks extended downward from one side thereof for resisting against said first rails.

9. A holder for variable-sized image recording mediums, comprising:
a first outer frame member having a groove formed in one side thereof along a longitudinal dimension;
a second outer frame member having a groove formed in one side thereof along a longitudinal dimension, said grooves of said first outer frame member and said second outer frame member opposite to each other and at the same horizontal level;
a third outer frame member having a groove formed in one side thereof along a longitudinal dimension, said third outer frame member connected to one end of said first outer frame member and said second outer frame member, and said groove of said third outer frame member at a horizontal level different from that of said groove of said first outer frame member;
a fourth outer frame member having a groove formed in one side thereof along a longitudinal dimension, said fourth outer frame member connected to the other end of said first outer frame member and said second outer frame member, and said grooves of said third outer frame member and said fourth outer frame member opposite to each other and at the same horizontal level;
at least one first rail positioned between said first outer frame member and said second outer frame member, each of which having a protrusion extended from each end thereof for being movably inserted in said grooves of said third outer frame member and said fourth outer frame member; and
at least one second rail positioned between said third outer frame member and said fourth outer frame member, said second rail having a protrusion extended from each end thereof for being movably inserted in said grooves of said first outer frame member and said second outer frame member, so that a plurality of variable-sized enclosures are formed in said holder.

10. The holder of claim 9, wherein each of said first outer frame member and said second outer frame member has a protrusion extended from each of the ends thereof connected to said third outer frame member and said fourth outer frame member for being inserted in said grooves of said third outer frame member and said fourth outer frame member.

11. The holder of claim 9, wherein said second rail has a plurality of protruded blocks extended downward from one side thereof for resisting against said first rails.

12. The holder of claim 10, wherein said second rail has a plurality of protruded blocks extended downward from one side thereof for resisting against said first rails.

13. The holder of claim 9, wherein each of said first outer frame member and said second outer frame member has an extended plate from the side having said groove formed therein and opposite to said groove, and said first rails respectively opposite to said first outer frame member and said second outer frame member have an extended plate from the side thereof opposite to said extended plates of said first outer frame member and said second frame member.

14. The holder of claim 13, wherein each of said first outer frame member and said second outer frame member has a protrusion extended from each of the ends thereof connected to said third outer frame member and said fourth outer frame member for being inserted in said grooves of said third outer frame member and said fourth outer frame member.

15. The holder of claim 13, wherein said second rail has a plurality of protruded blocks extended downward from one side thereof for resisting against said first rails.

16. The holder of claim 14, wherein said second rail has a plurality of protruded blocks extended downward from one side thereof for resisting against said first rails.

17. The holder of claim 9, wherein each of said first outer frame member and said second outer frame member has an extended plate from the side having said groove formed therein and opposite to said groove, and each of said first rails has an extended plate from each of the sides thereof opposite to each other and at the same horizontal level of said extended plates of said first outer frame member and said second outer frame member.

18. The holder of claim 17, wherein each of said first outer frame member and said second outer frame member has a protrusion extended from each of the ends thereof connected to said third outer frame member and said fourth outer frame member for being inserted in said grooves of said third outer frame member and said fourth outer frame member.

19. The holder of claim 17, wherein said second rail has a plurality of protruded blocks extended downward from one side thereof for resisting against said first rails.

20. The holder of claim 18, wherein said second rail has a plurality of protruded blocks extended downward from one side thereof for resisting against said first rails.
